(19) United States
(12) Patent Application Publication
(10) Pub. No.: US 2025/0256812 A1
(43) Pub. Date: Aug. 14, 2025

(54) COMPOSITE MARINE DECKING ASSEMBLY AND RELATED METHODS

(71) Applicant: TEAKDECKING SYSTEMS, INC., SARASOTA, FL (US)

(72) Inventors: Richard J. STRAUSS, SARASOTA, FL (US); Philip DICARLO, SARASOTA, FL (US); Chad CZILLI, SARASOTA, FL (US)

(21) Appl. No.: 19/052,991

(22) Filed: Feb. 13, 2025

Related U.S. Application Data
(60) Provisional application No. 63/552,738, filed on Feb. 13, 2024.

(51) Int. Cl. B63B 3/48; B32B 3/26; B32B 5/18; B32B 37/06

(52) U.S. Cl. CPC B63B 3/48; B32B 3/26; B32B 5/18; B32B 37/06; B32B 2260/046; B32B 2266/0214; B32B 2307/7376; B32B 2605/12

(57) ABSTRACT

A method of producing a composite marine decking assembly. The method comprises placing an neoprene foam layer on an operational vacuum table and installing a forming assembly to define an enclosure area. The method optionally comprises prepping the exposed neoprene foam layer surface to apply a polyurethane layer. The method further comprises providing and mixing a resin part and a hardener part to obtain a polyurethane mixture. The method further comprises applying and spreading the polyurethane mixture on the top surface of the neoprene foam layer to obtain an adhered polyurethane layer. The method further comprises applying heat to the polyurethane layer to remove any formed bubbles and allowing curing thereof. The resulting sheet of the composite decking assembly may be removed from the vacuum table, sanded, routed and/or cut into individual panels according to the intended geometry.

### CROSS-REFERENCE TO RELATED APPLICATIONS

This application claims the benefit of U.S. provisional application No. 63/552,738 filed Feb. 13, 2024, which is hereby incorporated herein in its entirety by reference.

### FIELD

The present invention relates to the field of marine decking for marine vessels, and, more particularly, to a composite marine decking assembly and related methods.

### BACKGROUND

EVA (Ethylene Vinyl Acetate) foam decking is a popular choice for boat flooring due to its comfort, non-slip properties, and ease of installation. However, it does come with some drawbacks. For example, EVA foam is prone to wear and tear over time, especially in high-traffic areas and it can be easily scratched or gouged by sharp objects, fishing gear, or heavy equipment. In addition, not all EVA foam is UV-resistant, leading to faster degradation in sunlight.

The adhesive backing may fail over time, especially in hot climates or when exposed to saltwater frequently and poor surface preparation before installation can cause peeling and lifting. Water intrusion under lifted edges can also lead to mold and mildew growth.

EVA foam tends to retain heat, making it hot to the touch in direct sunlight and darker colors absorb more heat, making it uncomfortable for bare feet. Oil, fuel, and fish blood stains can be difficult to remove and some cleaning chemicals can degrade the material, limiting cleaning options. In addition, scuffs and discoloration occur over time, especially in lighter-colored foam.

Compared to traditional teak, marine carpet, or synthetic decking, EVA foam generally has a shorter lifespan and under heavy use, it may need replacement every few years. However, once adhered, removing EVA foam decking can be challenging and messy. The adhesive leaves behind a sticky residue that requires strong solvents or sanding to clean up and replacing individual sections seamlessly can be difficult.

Accordingly, the marine industry currently has a need to provide for a durable and slip-resistant composite decking assembly that may be installed on a variety of vessels such as boats, yachts, sailboats, catamarans, etc.

### SUMMARY

In view of the foregoing background, it is therefore an object of the present invention to provide an improved decking for a vessel. The present invention is directed towards composite marine decking assembly and related methods intended for use as slip-resistant floor surface. The composite marine decking assembly comprises a closed-cell polychloroprene (neoprene) foam layer and a polyurethane layer. The neoprene foam layer may have visual indicia simulating a natural wood appearance including grooves or channels to simulate wood planking widths and lengths. The method of making the composite marine decking includes providing a vacuum table to maintain a level surface during production. The method further comprises placing the neoprene foam layer on the vacuum table with the top surface of the neoprene foam layer facing upward and the bottom surface thereof being disposed in confronting relation to the surface of the vacuum table. The method further comprises providing a forming assembly. The forming assembly generally comprises side panels disposed around the sides of the neoprene foam layer to create an enclosure area.

Before applying and installing an adhesive transfer tape, the neoprene foam layer may be prepped and/or primed. This may generally involve cleaning the bottom surface with a 50/50 isopropyl alcohol to water mixture to remove contaminants. The surface may also be lightly abraded to roughen it to enhance adhesion of the transfer tape. A primer is not used in this method of making the composite marine decking. Instead, the polyurethane mixture is applied directly to the top surface of the neoprene foam layer.

The polyurethan mixture comprises a two-part polyurethane mixture, where a first part generally comprises a resin, whereas a second part generally comprises a hardener. The two parts of the polyurethane mixture are weighted in a container and are mixed manually or mechanically using a drill, mechanical mixer or other comparable mechanical tool. The method further comprises pouring or otherwise placing and/or evenly distributing the polyurethane mixture onto the top surface of the neoprene foam layer. This results in forming a polyurethane layer that is welded to the neoprene foam layer. The method further comprises applying heat to the top surface of the polyurethane layer as needed to remove any bubbles that may have formed during the process.

The method further comprises allowing the polyurethane layer to cure for at least about 4 hours while a vacuum is continuously applied to maintain the neoprene foam layer and the polyurethane layer substantially flat. This results in a composite marine decking assembly with the transfer tape disposed on the bottom of the neoprene foam layer and the polyurethane layer disposed on the top of the neoprene foam layer. The resulting sheets of the composite marine decking assembly are removed from the vacuum table once the polyurethane layer has cured. Optional steps associated with the inventive method comprise sanding the top polyurethane layer to reduce its thickness and/or routing custom patterns into the top surface of the sheets and/or panels of the inventive composite decking assembly. The method according to the present invention may also comprise cutting the sheets of the campsite decking assembly into individual decking panels according to the size and/or geometry of the intended installation site or area.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a top view of individual panels of the composite marine decking assembly according to the method of the present invention.

FIG. 2 is a perspective view of a neoprene foam layer disposed on a vacuum table according to the method of the present invention.

FIG. 3 is a perspective view of the neoprene foam layer with a forming assembly disposed on a vacuum table according to the method of the present invention.

FIG. 4 is a perspective view of an application of a primer to the neoprene foam layer according to another aspect of the method of the present invention.

FIG. 5A is a perspective view of the step of providing, measuring and/or weighting the resin part of a polyurethane mixture according to the method of the present invention.

FIG. 5B is a perspective view of the step of providing, measuring and/or weighting the hardener part of a polyurethane mixture according to the method of the present invention.

FIG. 5C is a perspective view of the step of mixing both parts of a polyurethane mixture according to the method of the present invention.

FIG. 6A is a perspective view of the step of placing a polyurethane mixture on the neoprene foam layer according to the method of the present invention.

FIG. 6B is a perspective view of the step of distributing the polyurethane mixture on the neoprene foam layer according to the method of the present invention.

FIG. 6C is a perspective view of the step of applying heat to a polyurethane mixture to remove formed bubbles according to the method of the present invention.

FIG. 7A is a perspective view of the top and sides of a composite decking assembly sheet produced according to the method of the present invention.

FIG. 7B is a perspective view of the bottom and side of a composite decking assembly sheet produced according to the method of the present invention.

FIG. 7C is a perspective view of a portion of the top and sides of a composite decking assembly sheet produced according to the method of the present invention.

FIG. 8 is a perspective view of a sanding unit used to reduce the thickness of a sheet of the composite decking assembly produced according to the method of the present invention.

FIG. 9 is a side view of a routing unit used to modify the visual appearance of individual sheets or panels of the composite decking assembly produced according to the method of the present invention.

FIG. 10 is a diagrammatic representation of the steps associated with the method of forming a composite marine decking assembly according to the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The present invention will benefit the by providing a composite marine decking assembly with a slip-resistant polyurethane top layer as well as a shock absorbing neoprene foam core. In addition to slip resistance, the polyurethane layer also provides for a durable and weather-resistant and repairable surface, which is ideal for marine environments. An even further benefit to the industry with such a composite decking assembly is the neoprene foam layer is lightweight and gives a resilient cushioning effect. Together this combination provides an advantageous non-skid marine decking solution.

An object of the invention is to ensure an even surface during production of the composite marine decking assembly. Another object of the invention is to provide for a reliable bonding surface to adhere the composite marine decking assembly to the intended deck surface of the marine vessel. Another object of the invention is the effective placement of the polyurethane mixture to enhance its own adhesion to the neoprene foam layer. Another object of the invention is to make a marine composite decking that can be selectively and efficiently sanded, routed and/or cut to the desired shape and appearance.

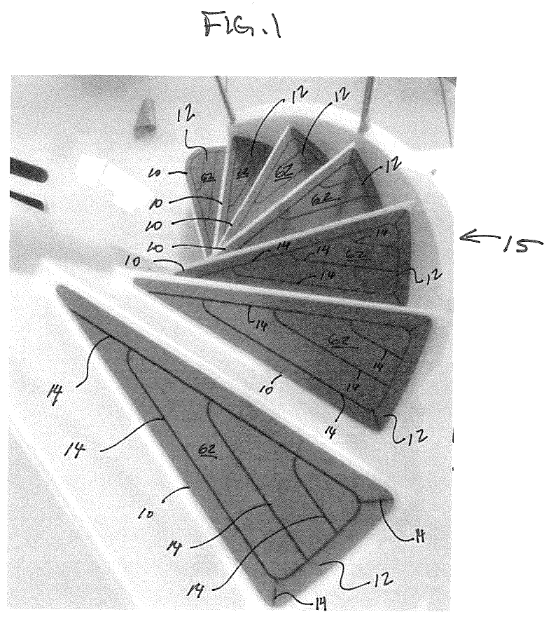

Referring now to FIG. 1, the composite marine decking assembly (also referred to herein as “marine decking”) is generally designated 100. Individual panels 12 have been cute from the marine decking assembly 100 and installed on a stairwell 15. The individual panels 12 include channels or grooves 14 formed in a top surface 62 for drainage, aesthetics, and to improve traction.

The panels 12 are primarily intended for use in connection with marine decking applications, e.g., decking for boats, yachts, sailboats, catamarans, etc., but may also be used in connection with other applications in which it is desirable to provide for a slip-resistant surface. Accordingly, the composite marine decking assembly 100 and decking 12 are generally manufactured according to the method 100 described below and generally comprise a closed-cell polychloroprene neoprene) foam layer adhered and bonded to a polyurethane layer.

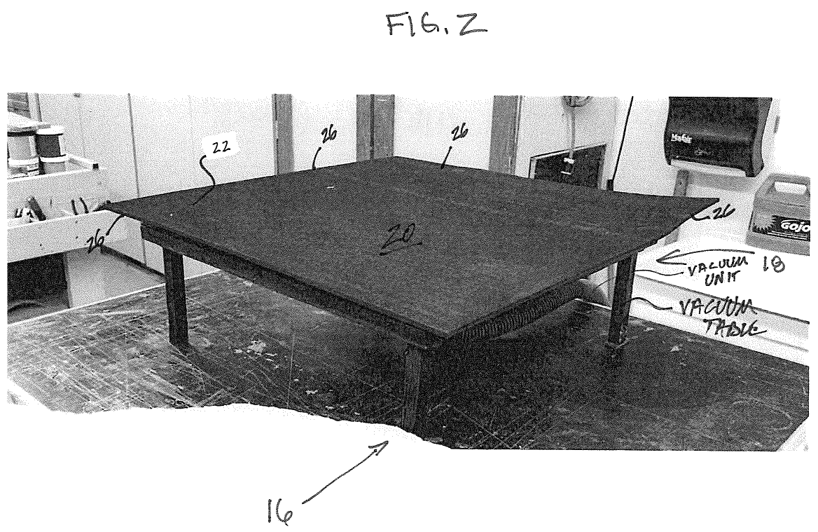

The method to make the marine decking 100 includes a vacuum table 16 as depicted in FIG. 2. The vacuum table 16 includes a vacuum unit 18 operatively disposed thereon. This is done with the goal of ensuring that the neoprene foam layer 20 may be laid on the vacuum table 16 and may be maintained substantially level during the remaining steps of the inventive method 100. The overall thickness of the neoprene foam layer 20 may be between about 3 millimeters (mm) to about 20 mm.

As is further shown in FIG. 2, the sides 26 of the neoprene layer 20 may extend beyond the edges of the vacuum table 16, for example, due to geometrical constraints. Alternatively, the sides 26 of the neoprene foam layer 20, may be cut to substantially coincide with the edges of the vacuum table 16. The top surface 22 of the neoprene layer 20 should face upward, whereas a bottom surface thereof should be disposed in confronting relation to the surface of the vacuum table 16. Furthermore, it is within the scope of the present invention that the inventive composite marine decking assembly 10 may comprise a transfer tape 18 disposed on the neoprene foam layer 20. For example, the neoprene foam layer 20 may be provided with transfer tape 18 already installed on a bottom face 64 thereof.

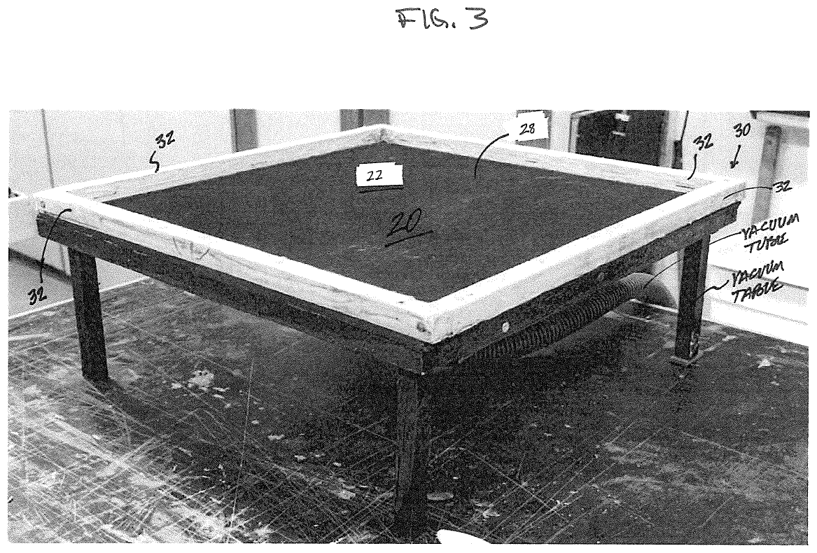

Referring now to FIG. 3, a forming assembly 30 is placed on the vacuum table 16. The forming assembly 30 generally comprises a plurality of guides 32 disposed around the sides 26 of the neoprene foam layer 20 and/or the edges of the vacuum table 16. As shown in the illustrative embodiment of FIG. 3, the guides 32 may substantially define a quadrilateral shape, e.g., a square shape, around the sides 26 of the neoprene foam layer 20. Furthermore, the guides 32 may be secured to either the neoprene foam layer 20 and/or vacuum table 16 itself. As such, the guides 32 may collectively define an enclosure area 28 around an interior thereof, i.e., inside of the quadrilateral. Such an enclosure area 28 should substantially from the top surface 22 of the neoprene foam layer 20 up to a top section of the guides 32.

The top surface 22 of the neoprene foam layer 20 is prepped as depicted in FIG. 4. Prepping may be done prior to application of a polyurethane mixture 50, which will be defined in more detail below. Prepping the top surface 22 of the neoprene foam layer 20 may involve using a clean cloth and applying a 50/50 IPA mixture, i.e., 50% Isopropyl Alcohol and 50% water, to the cloth and wiping the top surface 22 of the neoprene foam layer 20 in one direction to clean it.

Preparation of the top surface 22 of the neoprene foam layer 20 may also comprise lightly abrading the top surface 22. This may comprise providing a hand pad to lightly scuff the top surface of the neoprene foam layer 20, including making multiple passes, to provide or otherwise define a roughened top surface 22. Preparation of the top surface 22 of the neoprene foam layer 20 may further comprise using the cloth, e.g., with the 50/50 IPA mixture, to repeatedly wipe the top surface 22 as needed until it is substantially free from contaminants.

Once the top surface 22 of the neoprene foam layer 20 is prepped, it is ready to receive the polyurethane mixture 50. The polyurethane mixture comprises a Part A 52 and a Part B 54. The Part A 52 of the polyurethane mixture 50 generally comprises a resin or similar material, whereas the Part B 54 of the polyurethane mixture 50 comprises a hardener or similar material.

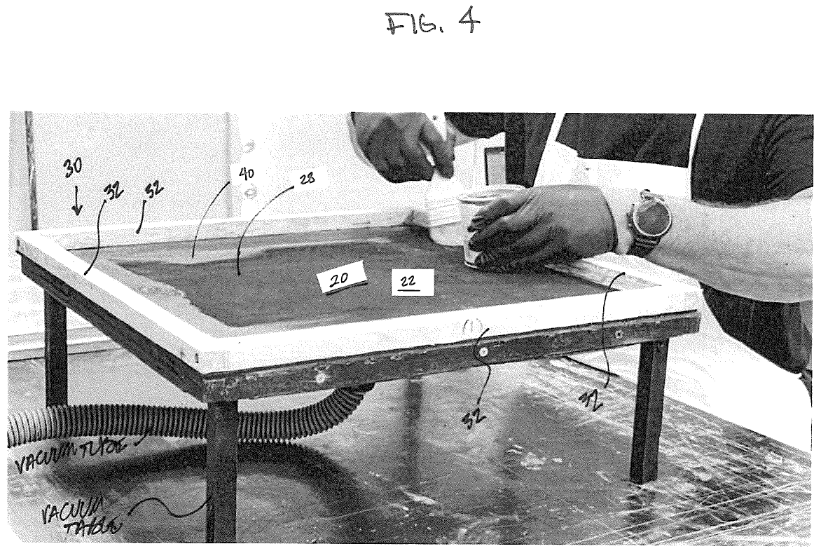

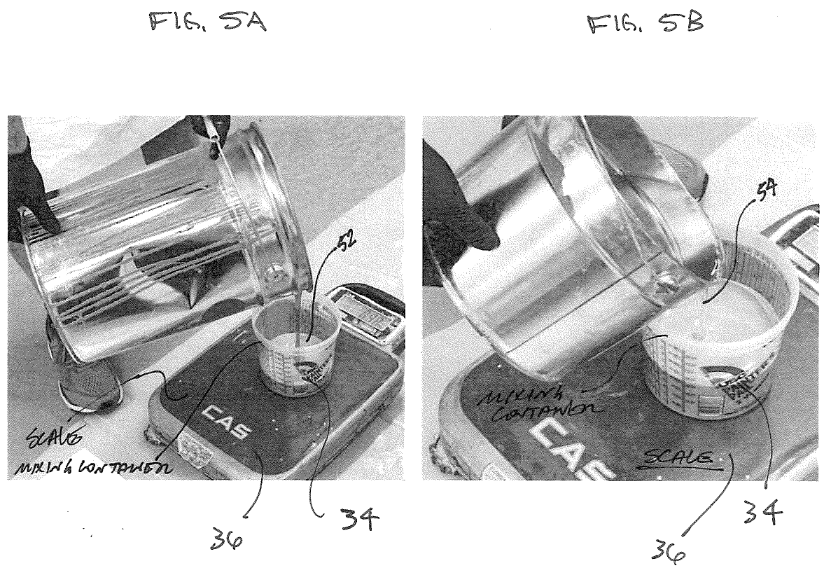

As shown in FIG. 5A, the resin component (Part A) 52 of the polyurethane mixture 50 may be weighted and placed into a mixing container 34. Thereafter, and as shown in FIG. 5B, the hardener component (Part B) 54 of the polyurethane mixture 50 may be weighted and placed into the mixing container 34 containing Part A. Here, the ratio in volume between Parts A and B may be about 3 to about 4 by volume, with beneficial results obtained with a ratio of about 77/23 by volume. As shown in FIGS. 5A-5B, the mixing container 34 may be placed on a weighting scale 36 to assist in determining the weight of Part A and/or Part B. As a further example, a predetermined polyurethane mixture 20 may comprise about 14.25 kilograms (kg) of the resin and about 4.25 (kg) of the hardener.

As shown in FIG. 5C, the polyurethane mixture 50 of Part A 52 and Part B 54 may be mixed, including manually and/or mechanically. By way of example only, and as shown in FIG. 5C, Part A 52 and Part B 54 may be mixed with a drill 38 operatively connected to an extension for about 2 minutes.

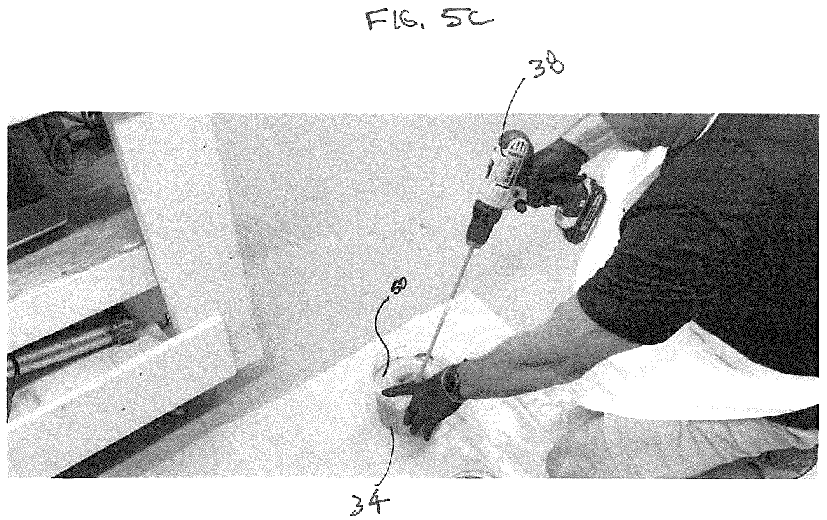

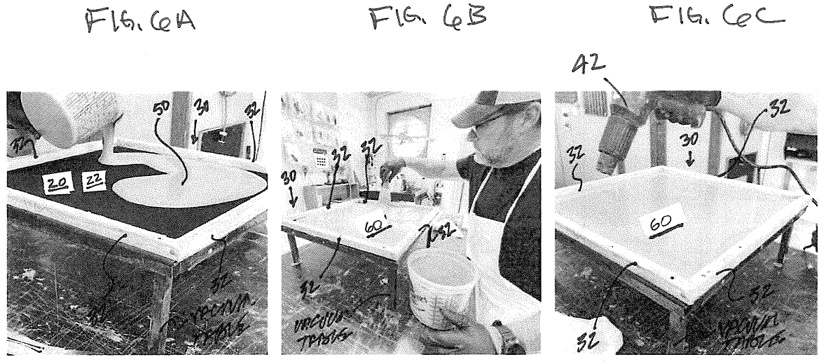

Referring now to FIG. 6A, the polyurethane mixture 50 is poured on to the top surface 22 of the neoprene foam layer 20. The polyurethane mixture 50 is distributed around the entire top surface 22 of the neoprene foam layer 20, to the outer edges along the guides 32, to create a polyurethane layer 60. By way of example, as shown in FIG. 6B, the polyurethane mixture 50 may be manually distributed around the top surface 22 of the neoprene foam layer 20. Thereafter, it is advantageous to wait sufficient time (e.g. five minutes) to allow gas particles, i.e., bubbles, to naturally form on the polyurethane layer 60.

A heat gun 42 or other comparable tool that can apply heat to the top surface of the polyurethane layer 60 may be used to remove any formed bubbles, as depicted in FIG. 6C. This process of removing formed bubbles may be repeated more than once depending on the need.

After removing any formed bubbles, the polyurethane layer 60 is allowed to cure for at least about 4 hours. Curing of the polyurethane layer 60 occurs while the vacuum table 16 and apply suction to keep the neoprene foam layer 20 flat.

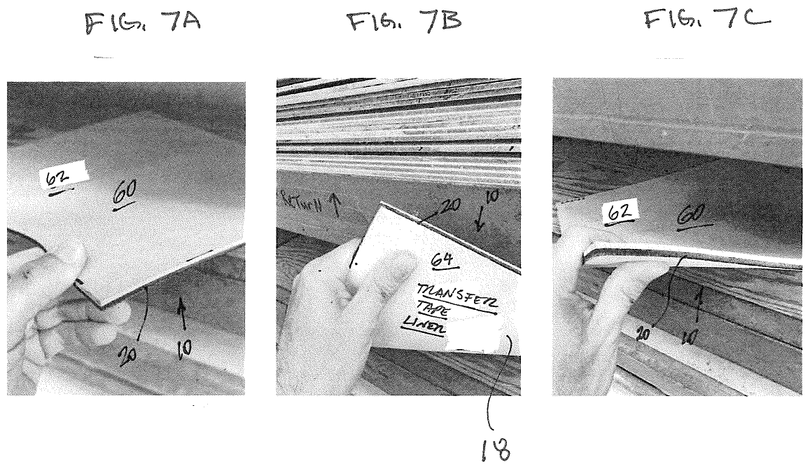

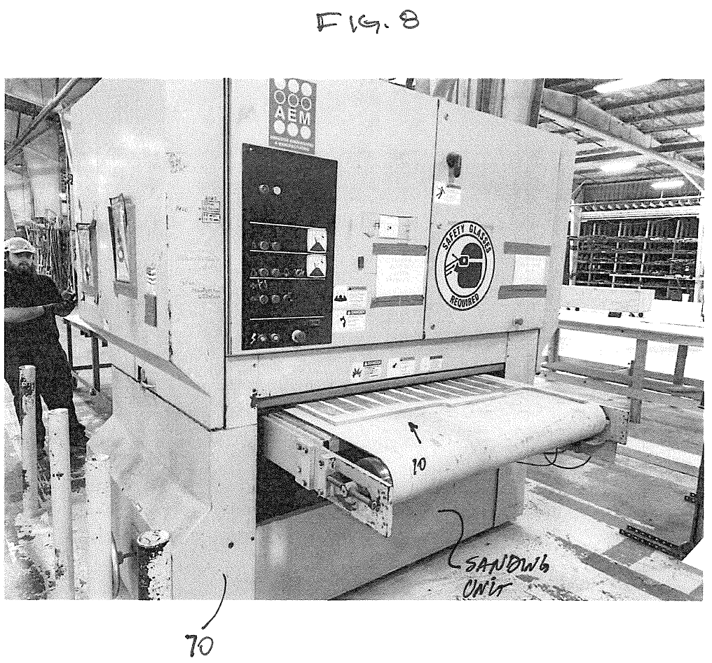

The composite marine decking assembly 10 can be removed from the vacuum table 16 after the polyurethane layer 60 has cured and bonded to the neoprene layer 20, as depicted in FIG. 7A. A top face 62 of the polyurethane layer 60 will be substantially coincident with the top face of the composite decking assembly 10 sheet. Further, the bottom 64 of the composite marine decking assembly 10 should comprise the transfer tape 18 that is covered by a removable liner. As such, the bottom face 64 of the composite decking assembly 10 will be adhered to the intended marine vessel surface once the tape liner is removed to install individual panels 12 thereof as shown, for example, in FIG. 1.

Conversely, the top of the composite decking assembly 10, i.e., the top face 62 of the polyurethane layer 60, will be exposed to the exterior/environment and which will support user traffic, weight of objects, etc. As an example, individual sheets of the inventive composite decking assembly may comprise a dimension of about 46.5 inch by about 93.5 inch.

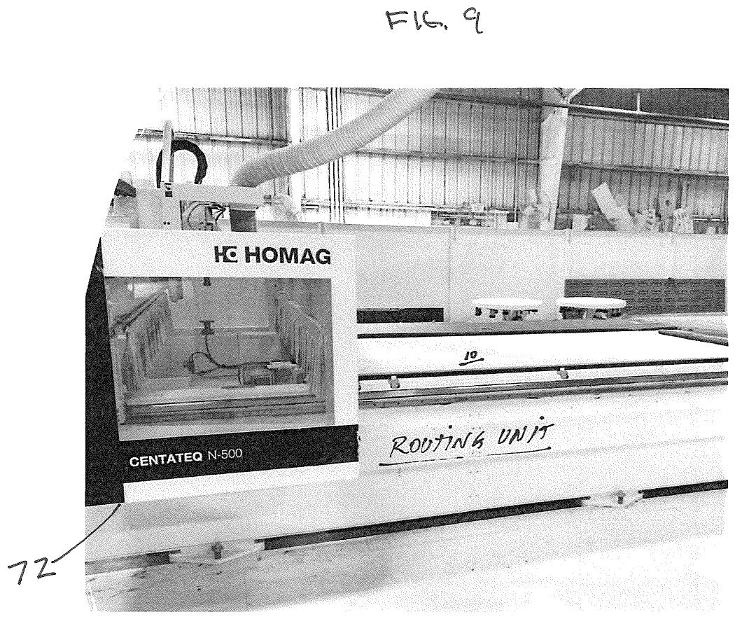

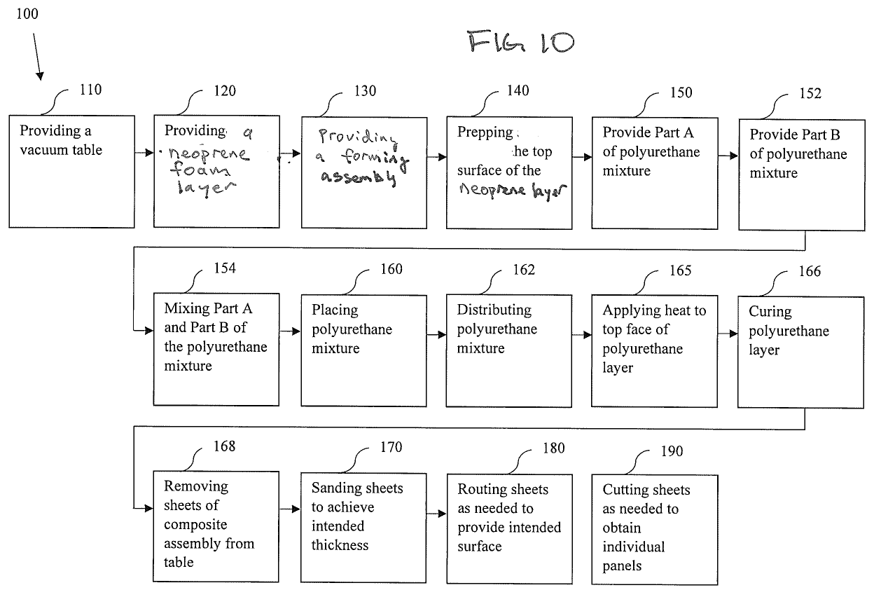

Referring now to FIG. 8, the composite decking assembly 10 can be sanded using a sanding unit (e.g. a planar) 70 or other similar machinery to achieve an intended thickness. For example, individual sheets of the composite decking assembly 10 may be passed through the sanding unit 70 configured to remove material from the top face 62 of the polyurethane layer 60. As an example, the resulting thickness of the polyurethane layer 60 may be reduced to about 2 mm.

In addition, the composite decking assembly 10 may pass through a routing unit 72 to achieve an intended pattern. For example, individual sheets of the composite decking assembly 10 may be passed through a computer numerical control (CNC) router 72, or other routing machine or equipment, to create a custom visual design on the top surface 62 of the polyurethane layer 60. As a further example, such custom patterns may comprise partially or fully routing through the polyurethane layer 60 to at least partially expose the neoprene foam layer 20 creating a contrast and providing for design definition. By way of example, the illustrative embodiment of FIG. 1 comprises a plurality of individual panels 12 that are cut to an intended size and that comprise a predetermined pattern that exposes via the routing process a plurality of channels 14 of the neoprene layer 20.

As described above, the composite decking assembly 10 may be cut into panels 12 of an intended size and/or geometry, including according to the location where the individual panels 12 will be installed on the marine vessel, i.e., decking for boats, yachts, sailboats, catamarans, etc. For example, the illustrative embodiment of FIG. 1 shows individual panels 12 of the composite decking assembly 10 cut to an intended size that corresponds to the geometry of the steps of a stairwell 15. Other configurations and/or geometric shapes and sizes are also possible.

Once the panels 12 are cut to their intended shape, they may be installed on an intended surface. Installation of the panels 12 generally comprises carefully peeling the liner of the transfer tape 18. Peeling the liner of the transfer tape 18 may begin from a corner followed by a continuous pulling motion. At this stage it is beneficial to avoid contact with any surface that may introduce contaminants, e.g., hands, clothes, dirty tools, etc. Thereafter, installation of the panels 12 includes guiding in increments of about 3 inches to about 4 inches at a time with the finger or hand of the user and applying a sufficient pressure to enable an adhesion of the transfer tape 18, and the panels 12 to the intended surface. Here, it is recommended not to stretch the transfer tape 18. Thereafter, once the transfer tape 18, as well as the panels 12 have been substantially installed on the intended surface, the installation may further comprise applying a pressure to the top of the transfer tape 18 to increase adhesion thereof. For example, with a J-roller or a similar type of roller, a pressure of about 15 psi (pounds per square inch) may be applied to the top of the panels 12 to enable and/or increase adhesion thereof to the intended surface.

Referring now to FIG. 10, the method of making the composite marine decking assembly and panels is disclosed and generally designated 100. The method includes providing a vacuum table, at 110, and providing a neoprene layer, at 120, on top of the vacuum table. Moving to 130, the method includes providing a forming assembly around the neoprene layer and, at 140, prepping the top surface of the neoprene layer. The method includes providing Part A, at 150, providing Part B, at 152, and mixing Part A and Part B, at 154, to form the polyurethane mixture. In addition, the method includes placing the polyurethane mixture on the neoprene layer, at 160, and distributing the mixture, at 162, to extend to the guides and applying a vacuum to keep the neoprene layer flat until the polyurethane layer is cured. The method also includes applying heat to the top surface of the polyurethane layer, at 165, and, at 166, curing the polyurethane layer to form a sheet. The sheet is removed, at 168, from the vacuum table, and the sheet is sanded to the intended thickness, at 170. The sheet, at 180, is routed as needed to provide the intended surface, and the sheet is cut into individual panels, at 190.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A composite marine decking assembly comprising:
a first layer of neoprene foam having a top surface and a bottom surface; and
a second layer of polyurethane, wherein the second layer is bonded to the top surface of the neoprene foam.

2. The composite marine decking assembly of claim 1, further comprising transfer tape adhered to the bottom surface of the neoprene foam.

3. The composite marine decking assembly of claim 1, wherein the neoprene foam comprises closed cell neoprene.

4. The composite marine decking assembly of claim 1, wherein the second layer of polyurethane has a plurality of channels that at least partially expose the top surface of the neoprene foam to form a pattern.

5. The composite marine decking assembly of claim 1, wherein the first layer and the second layer form a sheet.

6. The composite marine decking assembly of claim 5, wherein the sheet has a thickness of two millimeters.

7. The composite marine decking of claim 1, wherein the polyurethane is formed from a mixture having a ratio of about 77/23 by volume of resin to hardener.

8. The composite marine decking of claim 1, wherein the top surface of the neoprene foam has visual indicia simulating a wood surface.

9. The composite marine decking of claim 1, wherein the second layer of polyurethane is bonded to the first layer of neoprene foam without a primer.

10. The composite marine decking of claim 1, wherein the composite marine decking assembly is configured to be cut into a plurality of individual panels.

11. The composite marine decking assembly of claim 1, wherein the neoprene foam comprises closed cell neoprene, wherein the top surface of the neoprene foam has visual indicia simulating a wood surface, and wherein the second layer of polyurethane has a plurality of channels that at least partially expose the top surface of the neoprene foam to form a pattern.

12. A method of making a composite marine decking assembly, the method comprising:
providing a vacuum table having a top surface;
placing a neoprene layer on the top surface of the vacuum table, the neoprene layer having a top surface and an opposing bottom surface;
placing guides of a forming assembly proximate edges of the top surface of the neoprene layer;
forming a polyurethane mixture;
pouring the polyurethane mixture on to the top surface of the neoprene layer and distributing the polyurethane mixture to the guides; and
applying a vacuum to keep the neoprene layer flat on the vacuum table until the polyurethane layer is cured to form a sheet.

13. The method of making the composite marine decking assembly of claim 12, further comprising applying heat to a top surface of the polyurethane layer to remove bubbles from the polyurethane mixture.

14. The method of making the composite marine decking assembly of claim 12, further comprising removing the sheet from the vacuum table and sanding the sheet to an intended thickness.

15. The method of making the composite marine decking assembly of claim 14, further comprising routing the sheet to provide an intended surface condition, and cutting the sheet into a plurality of individual panels.

16. A marine vessel having a composite marine decking, the marine vessel comprising:
a hull;
a deck extending over the hull and having the composite marine decking applied over the deck, the composite marine decking comprising,
a first layer of neoprene foam having a top surface and a bottom surface, and
a second layer of polyurethane, wherein the second layer is bonded to the top surface of the neoprene foam.

17. The marine vessel of claim 16, wherein the neoprene foam comprises closed cell neoprene.

18. The marine vessel of claim 17, wherein the composite marine decking having a plurality of channels formed within the neoprene foam.

19. The marine vessel of claim 18, wherein the composite marine decking has a thickness of two millimeters.

20. The marine vessel of claim 19, wherein the top surface of the neoprene foam having visual indicia simulating a wood surface.
